(19) United States
(12) Patent Application Publication
(10) Pub. No.: US 2004/0194009 A1
(43) Pub. Date: Sep. 30, 2004

(54) Automated understanding, extraction and structured reformatting of information in electronic files

(76) Inventors: Christina LaComb, Cropseyville, NY (US); Joshua Temkin, Clifton Park, NY (US); Melvin Simmons, Schenectady, NY (US); Eric Klein, Schenectady, NY (US); Marc Laymon, Clifton Park, NY (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/401,259

(22) Filed: Mar. 27, 2003

(51) Int. Cl. G06F 17/21

(52) U.S. Cl. 715/500

(57) ABSTRACT

Systems and methods for automatically understanding, decomposing, extracting, validating and reformatting unstructured tabular information into intermediate structured representations of the information contained therein are described. No constraints are placed on the origin or format of these documents when originally submitted. Furthermore, no pre-created scripts are required to map the information contained in the submitted documents. The systems and methods of this invention generally comprise obtaining an electronic document, automatically analyzing and understanding the contents of the document, extracting information from the document, categorizing the information, and then creating an intermediate structured representation of the information contained therein. The intermediate structured representations may then be easily converted for use in a myriad of back-end systems. Embodiments of this invention automatically process a multitude of financial documents, thereby eliminating the need for human interaction with such documents in many cases and lowering the costs associated with processing such documents.

### CROSS REFERENCE TO RELATED APPLICATIONS

This invention is related to commonly-owned, co-pending U.S. patent application Ser. No. ______, entitled “Automated Understanding and Decomposition of Table-Structured Electronic Documents,” filed herewith, which is hereby incorporated in full by reference. This invention is also related to commonly-owned, co-pending U.S. patent application Ser. No. ______, entitled “Mathematical Decomposition of Table-Structured Electronic Documents,” filed herewith, which is also hereby incorporated in full by reference.

### FIELD OF THE INVENTION

The present invention relates generally to systems and methods for automatically processing electronic documents. More specifically, the present invention relates to systems and methods that automatically understand, decompose, extract, validate and then reformat unstructured tabular information into intermediate structured representations of the information contained therein, which can be easily converted for use in a myriad of back-end systems.

### BACKGROUND OF THE INVENTION

Financial statements such as balance sheets, income statements, cash flow statements, and the like, are commonly generated for businesses. Such statements may be formatted as tables of information, for example, in ASCII text, EBCDIC text, Microsoft Excel spreadsheets, PDF files, Postscript files, HTML documents, or the like. When reviewing such information, humans use inherent layout features, such as alignment and positioning, as clues for interpreting the logical meaning of the information contained therein. While such information is capable of being read and understood by a person, it may not be so easily read and understood by a computer. Therefore, and since human intervention is subject to error, it would be desirable to have a way to identify, extract, and break down the information contained in documents, such as financial statements, so that computers could be used to “understand” such documents. Such documents could then be reconstructed into intermediate structured representations of the information contained therein, such as for example, as XML-formatted documents. Thereafter, the intermediate structured representations of the documents could be converted into various formats capable of being integrated with other systems, such as data warehouses, underwriting and origination systems. Having an intermediate structured format would significantly ease integration efforts by providing a single format from which all other formats could be derived. This would make exchanging information between parties and/or businesses much easier than currently possible.

While there are currently systems and methods that allow some such documents to be understood, these systems and methods all impose certain constraints on the documents that are being submitted. For example, they may require that the documents be presented in a standardized format, or they may require that the system have pre-defined information about the format that is expected in the submitted document. For example, commonly-owned U.S. patent application Ser. No. 09/391,573, entitled “Methods and Apparatus for Print Scraping” describes systems and methods for automatically understanding and extracting information from such documents, but these systems and methods require the document type to be pre-classified as to what type of document it is, and they rely on the use of pre-created scripts that operate on a per-customer and/or per-document type basis to map the information contained therein. Additionally, commonly-owned U.S. patent application Ser. No. 09/391,773, entitled “Methods and Apparatus for Network-Enabled Virtual Printing” describes systems and methods for capturing information from a document, compiling the captured information into a temporary file, and then communicating the captured information in the temporary file to a remote system where the information can be processed. However, this invention also relies on the use of pre-created scripts that operate on a per-customer and/or per-document type basis to map the information contained therein. It would be desirable to have systems and methods that did not impose such constraints on documents. For example, it would be desirable to have systems and methods that would allow documents to be submitted in any format (i.e., that would allow formats typically generated by commercially-available tools, as well as formats indicative of the financial industry, to be submitted). It would be further desirable to have systems and methods that did not require the use of pre-created scripts to map the information contained therein, instead allowing the information to be automatically understood by the dynamic system.

There are presently no systems and methods available for allowing computers to understand documents that are submitted in any format, not just those submitted in a standardized format. Additionally, there are presently no systems and methods available for understanding documents automatically, without requiring the use of pre-created scripts to map the information contained therein. Thus, there is a need for such systems and methods. There is also a need for such systems and methods to automatically identify, extract and break down information contained in such documents into its constituent parts, and convert the documents into intermediate structured representations of the information contained therein, such as into XML-formatted documents or the like. There is yet a further need for such systems and methods to be capable of converting the intermediate structured documents into various formats that can be integrated with other systems. There is particularly a need for such systems and methods to be capable of understanding and converting financial documents into intermediate structured representations of the information contained therein, which can then be utilized with a variety of existing financial and data warehousing systems. Many other needs will also be met by this invention, as will become more apparent throughout the remainder of the disclosure that follows.

### SUMMARY OF THE INVENTION

Accordingly, the above-identified shortcomings of existing systems and methods are overcome by embodiments of the present invention, which relates to systems and methods that allow computers to automatically understand documents that are submitted in any format, not just those that are submitted in a standardized format. This invention also relates to systems and methods that automatically understand such documents, without requiring the use of pre-created scripts to map the information contained therein. In some embodiments, these systems and methods automatically identify, extract and break down information contained in such documents into its constituent parts, and convert the documents into intermediate structured representations of the information contained therein, such as into XML- formatted documents or the like. Embodiments of the systems and methods of this invention may also be capable of converting the intermediate structured documents into various formats that can be integrated with other systems. Furthermore, embodiments of the systems and methods of this invention may be capable of understanding and converting financial documents into intermediate structured representations of the information contained therein, which can then be utilized with a variety of existing financial and data warehousing systems.

One embodiment of this invention comprises a method for automatically understanding a document. This method may comprise utilizing algorithms to automate the understanding of a document, wherein no prior identification of a document type is required, no prior identification of an expected format for the document type is required, and no pre-created scripts are required to map contents of the document. These algorithms may comprise table decomposition algorithms, financial aspect identification algorithms, mathematical structure decomposition algorithms, accounting categorization algorithms, and/or validation algorithms.

Another embodiment of this invention comprises a method for understanding a document and converting it into an intermediate structured representation of the information contained therein. This method may comprise obtaining a document; utilizing algorithms to automatically understand the document; and creating an intermediate structured representation of the information contained therein from the extracted information, wherein no prior identification of a document type is required, no prior identification of an expected format for the document type is required, no pre-created scripts are required to map contents of the document, and the intermediate structured representation of the information is capable of being exchanged across diverse hardware, operating systems and applications. The algorithms that are used to automatically understand the document are preferably capable of: analyzing information contained in the document; decomposing the information contained in the document; extracting the decomposed information; categorizing the decomposed information; and validating the decomposed information.

Yet another embodiment of this invention comprises a system for understanding a document and converting it into an intermediate structured representation of the information contained therein. This system may comprise a means for obtaining a document; a means for utilizing algorithms to automatically understand the document; and a means for creating an intermediate structured representation of the information contained therein from the extracted information, wherein no prior identification of a document type is required, no prior identification of an expected format for the document type is required, no pre-created scripts are required to map contents of the document, and the intermediate structured representation of the information is capable of being exchanged across diverse hardware, operating systems and applications. The means for utilizing algorithms to automatically understand the document preferably further comprises: a means for analyzing information contained in the document; a means for decomposing the information contained in the document; a means for extracting the decomposed information; a means for categorizing the decomposed information; and a means for validating the decomposed information.

Further features, aspects and advantages of the present invention will be more readily apparent to those skilled in the art during the course of the following description, wherein references are made to the accompanying figures which illustrate some preferred forms of the present invention, and wherein like characters of reference designate like parts throughout the drawings.

### DESCRIPTION OF THE DRAWINGS

The systems and methods of the present invention are described herein below with reference to various figures, in which:

FIG. 1 is a high level diagram showing the basic operations that are performed in one embodiment of this invention;

FIG. 2 is a flowchart showing the basic steps followed by one embodiment of this invention; and

FIG. 3 is a flowchart showing in more detail the “understanding” operations that are performed by one embodiment of this invention.

### DETAILED DESCRIPTION OF THE INVENTION

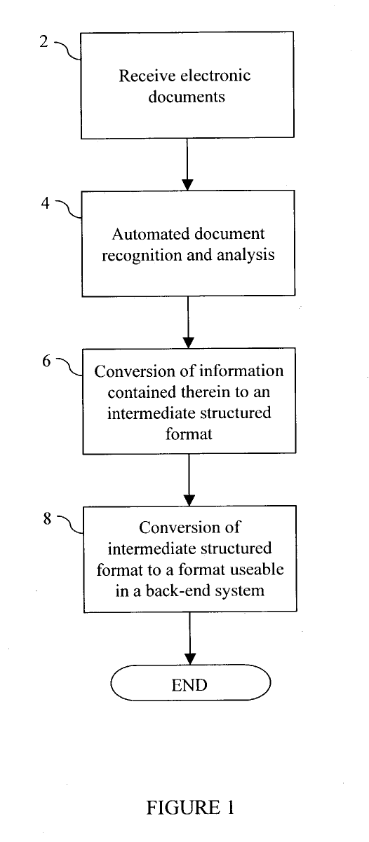

For the purposes of promoting an understanding of the invention, reference will now be made to some preferred embodiments of the present invention as illustrated in FIGS. 1-3, and specific language used to describe the same. The terminology used herein is for the purpose of description, not limitation. Specific structural and functional details disclosed herein are not to be interpreted as limiting, but merely as a basis for the claims as a representative basis for teaching one skilled in the art to variously employ the present invention. Well-known server architectures, web-based interfaces, programming methodologies and structures are utilized in this invention but are not described in detail herein so as not to obscure this invention. Any modifications or variations in the depicted systems and methods, and such further applications of the principles of the invention as illustrated herein, as would normally occur to one skilled in the art, are considered to be within the spirit of this invention.

The present invention comprises systems and methods that utilize a family of algorithms, preferably operationalized within a single engine or computer system, that can effectively decompose, categorize, validate and automate the extraction of information from tabular documents, and convert the documents into intermediate structured representations of the information contained therein that can be integrated with other systems, such as, for example, data warehouses, underwriting, and origination systems. These systems and methods basically take unstructured tabular documents and, by being able to understand them, they can reformat the information contained therein into intermediate structured, standardized electronic formats, which can then be converted for use in a variety of back-end systems. Although many embodiments described herein relate to electronic ASCII-formatted financial documents, many other types and formats of documents could be utilized in this invention. For example, the tabular documents could be formatted as Microsoft Excel spreadsheets, PDF files, Postscript files, HTML documents, or the like. Furthermore, this invention could be utilized for any type of document, not just financial documents.

Embodiments of this invention are targeted to businesses that offer commercial loans. Typically, as part of the loan approval process, customers are required to submit financial statements, either once or periodically, for risk assessment and origination purposes. This invention provides systems and methods for automatically understanding such documents and putting them into a format that can be easily integrated with a myriad of systems, thereby providing optimum consistency, accuracy, and timeliness in the decomposition, validation, and integration of such documents, as well as providing more accurate tracking and validity testing of the submitted data. Automating the task of understanding such documents decreases the cost associated therewith, allowing for more frequent monitoring of high-risk customers, and thereby reducing lenders' overall risk.

Embodiments of the present invention may be used to have a computer “understand” any type of document and convert such documents into intermediate structured representations of the information contained therein (i.e., into XML-formatted documents or the like), which may then be integrated with other financial systems, such as data warehouses, underwriting and origination systems. In some embodiments, the documents received are electronic financial statements in ASCII format. However, documents may also be received in a variety of other formats, such as for example, via fax or hardcopy, that may then be scanned, have its characters extracted using optical character reading technology, and be saved as an electronic file(s). Additionally, electronic documents in the form of EBCDIC text, Microsoft Excel spreadsheets, PDF files, Postscript files, HTML documents, or the like may be submitted. This invention allows all such documents to be received and “understood;” no standardized format is required for the initial submission of the documents in this invention, and the document is not required to be pre-characterized as a certain type of document.

This invention comprises a set of tools that aid in the process of developing scripts for electronic data extraction, preferably from electronic table-structured financial statements. A set of deterministic rules is established and applied to decompose a financial document so that document analysis and recognition can be automated. These rules consider both the contents and the layout of the document to make sense of the information contained therein, utilizing visual clues that are presented throughout the document in the form of semantic and syntactic conditions. This invention allows any documents to be automatically “understood;” no pre-created scripts are required to map the contents of the documents in this invention.

FIG. 1 is a high level diagram showing the basic operations that are performed in one embodiment of this invention. First, the electronic documents are received by the system 2. These documents may be received in any format, such as for example, as ASCII documents, XML documents, Microsoft Excel spreadsheets, HTML documents, PDF files, Postscript files, or the like. Next, the systems and methods of this invention automatically recognize and analyze the documents 4 via a document-understanding engine that extracts the content of the documents. Here, the layout of the documents may be analyzed, the words and context of the documents may be determined, the contents may be extracted and categorized, and then the content may be validated using accounting rules and the like. Thereafter, the document-understanding engine may convert the document contents to an intermediate structured format 6, such as an XML format. Finally, the intermediate structured document may be converted into a format useable in a multitude of back-end systems 8.

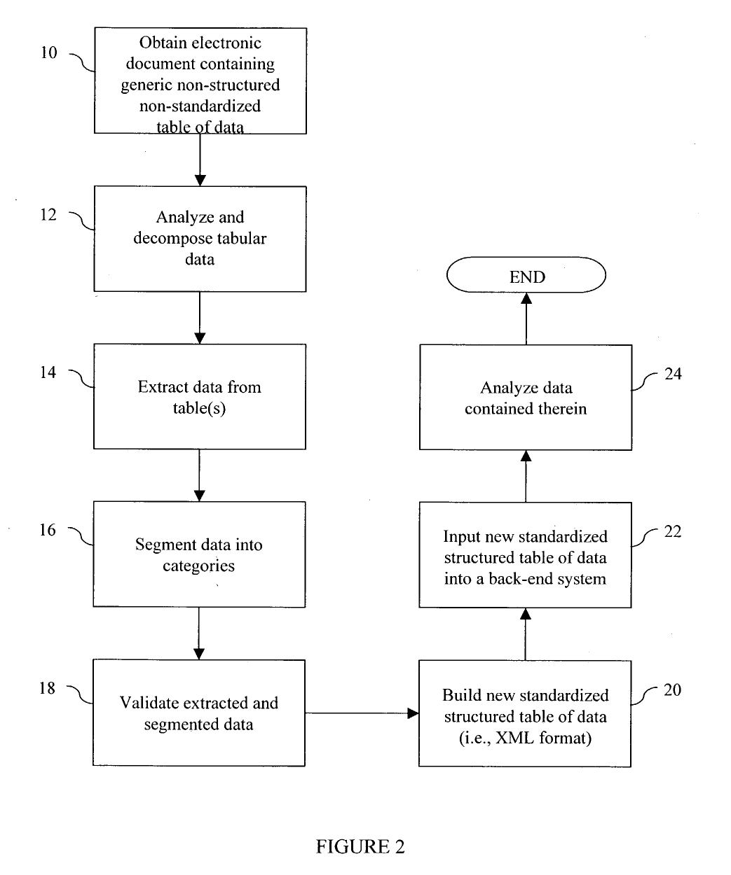

In a bit more detail now, the basic steps that are performed by a system in one embodiment of this invention are shown in FIG. 2. First, the system obtains an electronic document 10. This document may contain generic, non-structured and/or non-standardized tables of data. If the document, as submitted, is not in electronic format, it may first need to be scanned and saved as a flat file. Thereafter, the tabular data may be analyzed and decomposed 12 by the system, and the data may be extracted from the document 14. The system may then segment the extracted data into various categories 16, and validate the extracted data 18. Thereafter, a new, structured, standardized intermediate representation of the information contained therein may be created 20. In embodiments, once an intermediate standardized, structured intermediate format exists, such a format may be converted for use in various financial systems 22, where the data contained therein can be analyzed 24.

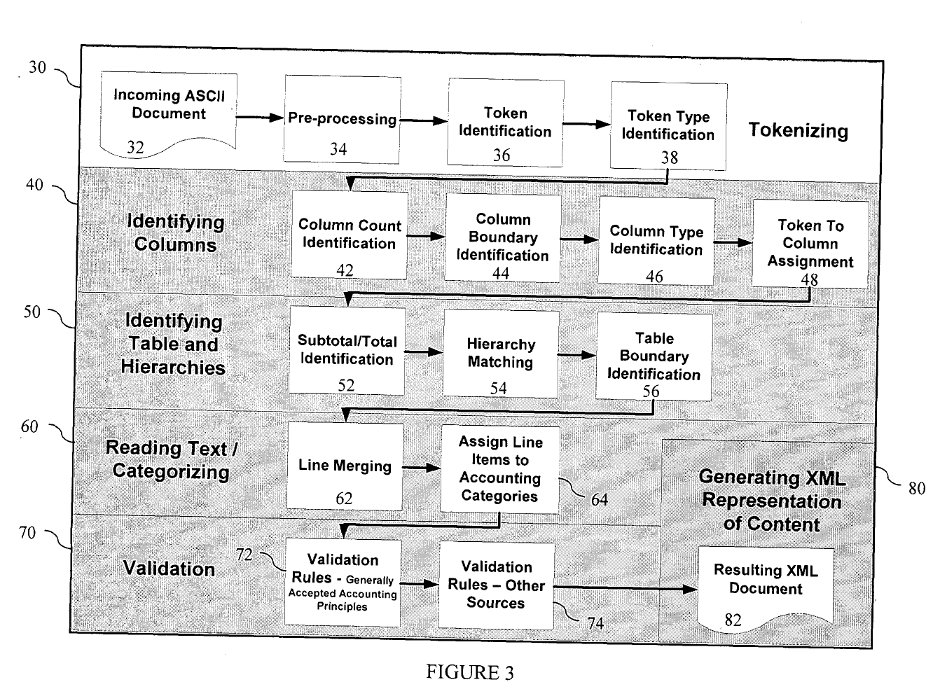

FIG. 3 is a flowchart showing, in more detail, the “understanding” operations that are performed by one embodiment of this invention. Generally speaking, the understanding process can be broken down into 6 different categories: tokenizing 30, identifying columns 40, identifying table and hierarchies 50, reading text and categorizing 60, validation 70, and generating an intermediate representation of the document contents 80. Each of these steps may comprise several other steps, as shown herein. Tokenizing may comprise receiving the incoming unstructured document 32, which is shown as being an ASCII document in this embodiment. This document may then be pre-processed 34, the tokens therein may be identified 36, and the token types may be identified 38. Thereafter, in the identifying columns step 40, the column count may be identified 42, the column boundaries may be identified 44, the column types may be identified 46, and the tokens may be assigned to columns 48. In the identifying the table and hierarchies step 50, the subtotals and totals may be identified 52, the hierarchies may be matched 54, and the table boundaries may be identified 56. In the reading the text and categorizing step 60, the lines may be merged 62, and the line items may be assigned to accounting categories 64. Thereafter, in the validation step 70, the validation rules may be applied, such as generally accepted accounting principles 72 and rules from other sources 74. Finally, the contents of the unstructured document may be organized in an intermediate structured representation of the contents therein 80, such as in an XML-formatted document 82. Each of these steps generally comprises algorithms that will be discussed in more detail below.

Preferably, the new structured, standardized intermediate representations of the information contained in such documents comprises an XML-rendering of the extracted information, which is capable of being easily integrated with other financial systems, such as data warehouses, underwriting and origination systems. XML is a standard, simple, self-describing way of encoding both text and data so that content can be processed with relatively little human intervention, and can then be exchanged across diverse hardware, operating systems, and applications. XML offers a widely adopted standard way of representing text and data in a format that can be processed without much human or machine intelligence. XML-formatted information can be exchanged across a variety of platforms, languages, and applications, and can be used with a wide range of development tools and utilities. While XML-formatting is specifically discussed herein as a preferred embodiment of the intermediate structured format, it will be apparent to those skilled in the art that there are numerous other manners of formatting this intermediate structured document, and all such manners are deemed to be within the scope of this invention.

In a preferred embodiment of this invention, the documents received comprise ASCII-renditions of financial documents that are received as electronic files via the Internet. The automated document analysis and recognition steps preferably comprise: analyzing the layout of the document, determining the words and context of the information contained therein, extracting and categorizing the information contained therein, validating the extracted information using accounting rules and historical information, and creating an intermediate XML-rendering of the extracted information. This intermediate XML-rendering of the extracted information may then be easily converted for use in one or more target financial systems.

There are many ways in which a financial document can be rendered an ASCII file, which can then be transmitted to a system of the present invention via the Internet. Many commercially available financial tools can output their contents directly as ASCII documents. If a financial software package does not support output in the form of a standard character set such as ASCII or EBCDIC, generally users can either “Save As Text” or print to a generic ASCII printer through Microsoft Windows. Once an ASCII rendering is obtained, users can easily attach the ASCII file to an electronic mail message and send it to a predetermined e-mail address. Alternatively, the ASCII file may be transmitted to a predetermined host via FTP or HTTP. The systems and methods of this invention are designed to support and monitor the transmission of all such file types.

“Print to HTTP” technology has also been created, which comprises a Microsoft Windows print driver that effectively converts any Windows output to an ASCII file, and then automates HTTP upload of the file to a pre-designated URL. Using such technology eases the operations that are required to generate the electronic versions of the financial statements submitted.

As previously discussed in conjunction with FIG. 3, upon receipt of the ASCII document, the , systems of this invention execute a series of algorithms designed to understand the document's contents based on semantic and syntactic clues located throughout the document. No pre-created scripts are required to map the contents of the documents. These algorithms automate the “understanding” of the financial documents, removing the requirement for human intervention in cases where the information contained in such documents can be effectively “understood” by a computer. These algorithms are preferably operationalized within five separate categories: (1) Table Decomposition; (2) Financial Aspect Identification; (3) Mathematical Structure Decomposition; (4) Accounting Categorization; and (5) Validation.

The Table Decomposition algorithms may comprise algorithms for performing: token identification, token type identification, column count identification, column boundary identification, column type identification, token-to-colunm assignment, and/or line merging. The token identification algorithm may comprise utilizing spacing information between words to identify which words should be grouped together as a single portion of the table. The token type identification algorithm may comprise using special characters and alphanumeric combinations to determine whether the token represents text, a number, or a date. The column count identification algorithm may comprise identifying the appropriate number of columns in the document based on statistical measures of the token count per line/row. The column boundary identification algorithm may comprise identification of suitable column boundaries based on the right-most and left-most position of all tokens assigned to each column. The column type identification algorithm may comprise assigning a column type to each column based on the frequency of each token type within each column. The token-to-column assignment algorithm may comprise assigning tokens from each row to their respective columns based on their sequential position within the row, and their proximity to other tokens. Finally, the line-merging algorithm may comprise using key separator words to identify wrapping lines (i.e., lines that occupy more than one row in the table).

The Financial Aspect Identification algorithms may comprise algorithms for performing: identification of date periods for the documents, identification of audited/un-audited status, and/or identification of dollar units in the documents (i.e., thousands, millions, etc.). The algorithm for identifying date periods in the document may comprise a set of heuristics that can interrogate date portions throughout the document to assemble a picture of the date periods covered by each column. The algorithm for identifying audited/un-audited status may take the form of searching the document for key phrases that indicate whether or not the financial statement has been audited. Finally, the algorithm for identifying dollar units in the document may comprise identifying key word patterns that indicate the dollar units in the document.

The Mathematical Structure Decomposition algorithms may comprise algorithms for performing: table boundary identification, total identification, and/or subtotal identification. The table boundary identification algorithm may comprise identifying key word patterns and mathematical relationships that identify the start and end of the table. The total identification algorithm may comprise identifying word patterns that indicate relevant totals of the document. The subtotal identification algorithm may comprise identifying lines that indicate subtotals, have no line item description, and/or are mathematical compositions of other line items within the document.

The Accounting Categorization algorithms may comprise algorithms for performing: hierarchy matching (i.e., current vs. long term) and/or assignment of the line items to accounting categories. The hierarchy-matching algorithm may comprise splitting the document into its hierarchical parts by using word patterns to identify key segments. The assignment algorithm may comprise using the line item description and the row position related to the hierarchy headers to determine the suitable categorization for each line item.

Finally, the Validation algorithms may comprise algorithms for performing validation using: generally accepted accounting principles (GAAP), historical trends and/or other sources. The validation algorithm may comprise ensuring that the summation of the line items assigned to a given category equals the total given for that category.

Once the information contained in the document is analyzed, decomposed, extracted and validated, the information may be easily regenerated as an intermediate structured representation of the target document type (i.e., balance sheet, income statement, cash flow statement, etc.). The intermediate structured representation may comprise any suitable format, such as XML or the like. A number of existing XML standards are available for representing the contents of financial documents, with the Extensible Business Reporting Language (XBRL) standard appearing to be the most widely favored within the industry. However, any suitable XML standard that effectively characterizes the target document type may be used, as can any other format that effectively characterizes the target document type.

Once an intermediate structured representation of the information exists, the intermediate structured representations may be submitted to one or more target financial systems. By utilizing a commercial-off-the-shelf ETL (Extract, Transform and Load) tool such as Data Junction or Informatica, no custom coding should be needed to convert the intermediate structured representations into the target data source. However, should the target data source not be supported by existing ETL tools, a custom solution could be built easily. Using the intermediate structured representations greatly eases integration efforts by providing a single standardized format from which all other formats can be derived. Furthermore, if XML documents are used, the XML documents are portable, self-describing, well-structured, internally consistent, vendor neutral, and are the de facto industry standard for data exchange between diverse systems. As such, they are easily integrated with a myriad of existing financial and data warehousing systems.

As described above, embodiments of the systems and methods of this invention allow electronic financial documents to be automatically processed, understood and reformatted into intermediate structured representations of the documents that can be easily integrated with various financial systems. Advantageously, these systems and methods place no constraints on the origin or format of the originally submitted documents, instead allowing any type of tabular document to be submitted for automatic processing. Additionally, these systems and methods allow documents to be automatically understood, without requiring pre-created scripts to map the information contained therein. Embodiments of this invention are targeted towards all types of financial table-structured ASCII documents, regardless of their origin, and no special constraints are placed on the format or origin of the documents that are submitted. The algorithms this invention utilizes are generally applicable to all financial table-structured documents. Furthermore, the secondary (i.e., validation) algorithms are used to test the effectiveness of the primary algorithms.

Various embodiments of the invention have been described in fulfillment of the various needs that the invention meets. It should be recognized that these embodiments are merely illustrative of the principles of various embodiments of the present invention. Numerous modifications and adaptations thereof will be apparent to those skilled in the art without departing from the spirit and scope of the present invention. For example, while this invention has been described in terms of systems and methods that automatically process electronic financial documents, numerous other types of tabular documents could be processed by the systems and methods of this invention. Thus, it is intended that the present invention cover all suitable modifications and variations as come within the scope of the appended claims and their equivalents.

What is claimed is:

1. A method for automatically understanding a document, the method comprising:
utilizing algorithms to automate the understanding of a document,
wherein no prior identification of a document type is required, no prior identification of an expected format for the document type is required, and no pre-created scripts are required to map contents of the document.

2. The method of claim 1, wherein the algorithms comprise table decomposition algorithms, financial aspect identification algorithms, mathematical structure decomposition algorithms, accounting categorization algorithms, and validation algorithms.

3. The method of claim 2, wherein the table decomposition algorithms comprise algorithms for performing at least one of the following: token identification, token type identification, column count identification, column boundary identification, column type identification, token-to-column assignment, and line merging.

4. The method of claim 3, wherein the token identification comprises utilizing spacing information between words to identify which words should be grouped together as a single portion of the table.

5. The method of claim 3, wherein the token type identification comprises using special characters and alphanumeric combinations to determine whether the token represents text, a number, or a date.

6. The method of claim 3, wherein the column count identification comprises identifying an appropriate number of columns in the document based on statistical measures of a token count per row.

7. The method of claim 3, wherein the column boundary identification comprises identification of suitable column boundaries based on right-most and left-most position of all tokens assigned to each column.

8. The method of claim 3, wherein the column type identification comprises assigning a column type to each column based on a frequency of each token type within each column.

9. The method of claim 3, wherein the token-to-column assignment comprises assigning tokens from each row to their respective columns based on their sequential position within the row and their proximity to other tokens.

10. The method of claim 3, wherein the line merging comprises using key separator words to identify wrapping lines.

11. The method of claim 2, wherein the financial aspect identification algorithms comprise algorithms for performing at least one of the following: identification of date periods for the document, identification of audited/un-audited status, and identification of dollar units in the documents.

12. The method of claim 11, wherein the identification of date periods for the document comprises utilizing a set of heuristics to interrogate date portions throughout the document to assemble a picture of the date periods covered by each column in the document.

13. The method of claim 11, wherein the identification of audited/un-audited status comprises searching the document for key phrases that indicate whether or not the financial statement has been audited.

14. The method of claim 11, wherein the identification of dollar units in the documents comprises identifying key word patterns that indicate the dollar units in the document.

15. The method of claim 2, wherein the mathematical structure decomposition algorithms comprise algorithms for performing at least one of the following: table boundary identification, total identification, and subtotal identification.

16. The method of claim 15, wherein the table boundary identification comprises identifying key word patterns and mathematical relationships that identify a start and an end of the table.

17. The method of claim 15, wherein the total identification comprises identifying word patterns that indicate relevant totals of the document.

18. The method of claim 15, wherein the subtotal identification comprises at least one of the following: identifying lines that indicate subtotals, identifying lines that have no line item description, and identifying lines that are mathematical compositions of other line items within the document.

19. The method of claim 2, wherein the accounting categorization algorithms comprise algorithms for performing at least one of the following: hierarchy matching and assignment of the line items to accounting categories.

20. The method of claim 19, wherein the hierarchy matching comprises splitting the document into its hierarchical parts by using word patterns to identify key segments.

21. The method of claim 19, wherein the assignment of the line items to accounting categories comprises using a line item description and a row position related to a hierarchy header to determine a suitable categorization for each line item.

22. The method of claim 2, wherein the validation algorithms comprise algorithms for performing validation utilizing at least one of the following: generally accepted accounting principles (GAAP) and historical trends.

23. The method of claim 22, wherein validation comprises ensuring that the summation of the line items assigned to a given category equals a total given for that category.

24. The method of claim 1, wherein the steps are performed automatically by a computer system.

25. A method for understanding a document and converting it into an intermediate structured representation of the information contained therein, the method comprising:
obtaining a document;
utilizing algorithms to automatically understand the document; and
creating an intermediate structured representation of the information contained therein from the extracted information,
wherein no prior identification of a document type is required, no prior identification of an expected format for the document type is required, no pre-created scripts are required to map contents of the document, and the intermediate structured representation of the information is capable of being exchanged across diverse hardware, operating systems and applications.

26. The method of claim 25, wherein the steps are performed automatically by a computer system.

27. The method of claim 25, wherein the algorithms used to automatically understand the document are capable of:
analyzing information contained in the document;
decomposing the information contained in the document;
extracting the decomposed information;
categorizing the decomposed information; and
validating the decomposed information.

28. The method of claim 27, wherein the steps are performed automatically by a computer system.

29. The method of claim 25, further comprising:
converting the intermediate structured representation of the information into a format capable of being used in one or more target systems.

30. The method of claim 29, wherein the converting step comprises utilizing an ETL tool to convert the intermediate structured representation of the information into a format capable of being used in one or more target systems.

31. The method of claim 25, wherein the document that is obtained is in the form of at least one of: an ASCII text document, an EBCDIC text document, a spreadsheet, a PDF file, a Postscript file, and an HTML document.

32. The method of claim 25, wherein the document that is obtained comprises a financial statement.

33. The method of claim 32, wherein the financial statement comprises at least one of: a balance sheet, an income statement, and a cash flow statement.

34. The method of claim 25, wherein the document that is obtained comprises an electronic document.

35. The method of claim 34, wherein the electronic document is obtained electronically via at least one of: the Internet, an electronic mail message, an intranet, an extranet, and a scanner.

36. The method of claim 25, wherein the method is utilized to analyze at least one of: a company's financial health and the integrity of the financial statement.

37. The method of claim 25, wherein the document that is obtained comprises tabular information.

38. A system for understanding a document and converting it into an intermediate structured representation of the information contained therein, the system comprising:
a means for obtaining a document;
a means for utilizing algorithms to automatically understand the document; and
a means for creating an intermediate structured representation of the information contained therein from the extracted information,
wherein no prior identification of a document type is required, no prior identification of an expected format for the document type is required, no pre-created scripts are required to map contents of the document, and the intermediate structured representation of the information is capable of being exchanged across diverse hardware, operating systems and applications.

39. The system of claim 38, wherein the steps are performed automatically by a computer system.

40. The system of claim 38, wherein the means for utilizing algorithms to automatically understand the document further comprises:
a means for analyzing information contained in the document;
a means for decomposing the information contained in the document;
a means for extracting the decomposed information;
a means for categorizing the decomposed information; and
a means for validating the decomposed information.

41. The system of claim 40, wherein the steps are performed automatically by a computer system.

42. The system of claim 38, further comprising:
a means for converting the intermediate structured representation of the information into a format capable of being used in one or more target systems.

43. The system of claim 42, wherein the means for converting the intermediate structured representation of the information into a format capable of being used in one or more target systems comprises utilizing an ETL tool to convert the intermediate structured representation of the information into a format capable of being used in one or more target systems.

44. The system of claim 38, wherein the document that is obtained is in the form of at least one of: an ASCII text document, an EBCDIC text document, a spreadsheet, a PDF file, a Postscript file, and an HTML document.

45. The system of claim 38, wherein the document that is obtained comprises a financial statement.

46. The system of claim 45, wherein the financial statement comprises at least one of: a balance sheet, an income statement, and a cash flow statement.

47. The system of claim 38, wherein the document that is obtained comprises an electronic document.

48. The system of claim 47, wherein the electronic document is obtained electronically via at least one of: the Internet, an electronic mail message, an intranet, an extranet, and a scanner.

49. The system of claim 38, wherein the system is utilized to analyze at least one of: a company's financial health and the integrity of the financial statement.

50. The system of claim 38, wherein the document that is obtained comprises tabular information.
